(19) United States
(12) Patent Application Publication
(10) Pub. No.: US 2019/0276362 A1
(43) Pub. Date: Sep. 12, 2019

(54) Unique Formulations/Mixtures and Unique and Improved Processes for Manufacturing Structural Insulated Panels Systems (SIPS)

(71) Applicants: MARC WINKELMAN, Chandler, AZ (US); JAMES PAUL JENKINS, Amity, OR (US)

(72) Inventors: MARC WINKELMAN, Chandler, AZ (US); JAMES PAUL JENKINS, Amity, OR (US)

(21) Appl. No.: 15/917,720

(22) Filed: Mar. 11, 2018

(51) Int. Cl. C04B 28/04; E04C 2/288; E04C 5/07; E04B 1/94; C04B 14/42; C04B 40/00; B28B 1/14; B28B 11/24; B28B 1/52

(52) U.S. Cl. CPC C04B 28/04; E04C 2/288; E04C 5/073; E04B 1/942; C04B 2111/27; C04B 40/0089; B28B 1/14; B28B 11/24; B28B 1/52; C04B 14/42

(57) ABSTRACT

The invention is the development of new and unique formulations and mixtures along with unique and improved manufacturing processes for a clear departure for all manufacturing processes in which cement-based formulations and mixtures are commonly utilized in manufacturing SIPS of the prior art and or the teachings of the poured/casted/formed cement based formulations/mixtures and manufacturing processes of the prior art of building/construction industry. The invention serves the current building/construction industry with new and unique formulations and mixtures along with unique and improved manufacturing processes that produce SIPS with enhanced performance characteristics which are unparalleled teachings not present, nor found in any of the prior art.

### CROSS REFERENCE TO RELATED APPLICATIONS:

There is no cross reference applicable.

### STATEMENT OF FEDERALLY SPONSORED RESEARCH:

There is no federally sponsored research for this invention.

### SEQUENCE LISTING, TABLE, COMPUTER PROGRAM:

There is no such Sequence Listing applicable.

### BACKGROUND OF INVENTION

Currently in the building and construction industry there are different types of Structural Insulated Panel Systems (SIPS) that are available for builders to construct many different types of structures. The prior art of SIPS teaches many different manufacturing processes that utilize a variety of materials in producing the various types of SIPS. The various aspects taught by the invention are totally new approaches to manufacture SIPS both in terms of the selection of materials used in making the new and unique formulations/mixtures and the unique and improved manufacturing processes that are used to produce the SIPS of the invention. These new innovations of the invention produce desirable and noteworthy attributes to be further detailed.

SIPS: Is an insulating foam core sandwiched between two structural facings. The prior art teaches that the foam cores of a SIPS are without exception either an Expanded Polystyrene (EPS) or Spray Polyurethane Foam (SPF). The prior art further teaches that the two structural facings can be a variety of materials of which the two most widely manufactured types of SIPS are produced with oriented strand board (OSB) or magnesium oxide cement board/mag board as the structural facings and the foam core being either ESP or SPF.

The largest quantities of SIPS being manufactured in the US are typically manufactured by using oriented strand board (OSB) or modified wood substances for the two structural facings. These OSB type SIPS consist of an insulating foam core of expanded polystyrene (EPS) glued and sandwiched between two sheets of 7/16″ OSB. There are many short-comings in the prior art of SIPS technologies:
OSB is unstable and will readily absorb water, swell, delaminate, and rot with the introduction of the small amount of water intrusion,
OSB is a wood product that is combustible and ignites easily. The same holds true with the expanded polystyrene foams (EPS). The OSB type SIPS panels cannot withstand nor survive the typical home fire. The typical home fire begins with an ignition of one or more of the homes contents that burns achieving temperatures of 1,100 degrees, which causes a condition of “flash-Over” causing an explosive combustion of everything in the home, including the wooden home structure itself.
OSB may contain formaldehyde and other undesirable and unhealthy chemicals. News reports have highlighted these environmental concerns regarding hazards of the out-gassing of chemicals into our immediate home environment.
OSB is a known food source choice of many bugs and insects, Such results nesting and colonization and does not inhibit rodent intrusion, as the rodents can chew right through the OSB and foam finding ideal nesting environment within the insulated panels.
Once OSB panels are erected the builder-contractor is still further tasked to purchase and apply exterior moisture barrier(s) to protect the structure from damage from water intrusion. The invention solves this problem by producing water tight integrity which is achieved in the new and unique formulations/mixtures and unique and improved manufacturing processes.
Once OSB panels are erected the builder-contractor is still further tasked to purchase and apply an exterior siding system(s) to complete the structure. The invention solves this problem by producing wide range of molded textures such as stucco/plaster, lapped siding, stone, and brick, etc. which are achieved in the unique and improved manufacturing processes.
Once panels are erected the builder-contractor is still further tasked to purchase and apply an interior finish system(s) to complete the structure. The invention solves this problem by producing wide range of molded textures such as stucco/plaster, drywall textures, wood paneling, stone, and brick. etc. which are achieved in the unique and improved manufacturing processes.
The OSB type SIPS panels are much weaker in strength when compared to the invention. OSB type SIPS panels are not adequately reinforced for structural load-bearing integrity and can sustain localized failure which can result in a catastrophic domino type sequence of panel failures leading to an overall structure failure.

The second largest quantities of SIPS being manufactured in the US are typically manufactured by using magnesium oxide cement board (MOCB) in place of OSB as the two structural facings of the SIPS. This prior art has short comings in the technologies taught as well:
Once the MOCB panels are erected the builder is still further tasked to purchase and apply an exterior moisture barrier(s) to protect the structure which is not otherwise waterproofed to prevent issues of water intrusion. The invention solves this problem by producing water tight integrity which is achieved in the new and unique formulations/mixtures and unique and improved manufacturing processes.
Once the MOCB panels are erected the builder is still further tasked to purchase and apply an exterior siding system(s) to complete the structure. The invention solves this problem by producing wide range of molded textures such as stucco/plaster, lapped siding, stone, and brick, etc. which are achieved in the unique and improved manufacturing processes.
Once the MOCB panels are erected the builder is still further tasked to purchase and install an interior finish system(s) to complete the structure. Typical interior finishes require gypsum board or plaster overlays and or any number of desirable aesthetic material textures requiring additional finishing. The invention solves this problem by producing wide range of molded textures such as stucco/plaster, drywall textures, wood paneling, stone, and brick. etc. which are achieved in the unique and improved manufacturing processes.
These types of MOCB panels have lower structural strength when compared to this invention. The MOCB panels are not reinforced structurally and can sustain localized failure which can result in a domino type catastrophic panel failure.

Note: The invention will make no further reference or comparison to the different types Structural Insulated Panel Systems (SIPS). The information provided on the different types SIPS were to simply detail the different types SIPS taught by the prior art. The invention creates a radically new classification/category/type of SIPS which utilizes totally new and unique formulations and mixtures of materials and unique and improved manufacturing processes not taught nor found in the prior art of SIPS.

The teaching of the invention articulates a SIPS consisting of an insulating Spray Polyurethane Foam (SPF) core sandwiched between two cement based structural facings. The invention will present the new and unique characteristics of the New Formulations/Mixtures and Unique and Improved Processes for Manufacturing Structural Insulated Panels Systems (SIPS) that qualify the invention in obtaining the right of Patent Protection by the USPTO for manufacturing the SIPS of the invention.

For the purposes of the invention being granted Patent Protection it is key that the new and unique formulations/mixtures for the two cement-based structural facings along the with the unique and improved manufacturing processes utilized in producing the SIPS of the invention be compared to historical methods of the poured/casted/formed cement based formulations/mixtures and processes taught by the prior art of building/construction industry as a whole. The invention is new and unique in its teaching of radically augmenting the typical cement-based methods of formulation and manufacturing processes taught by prior art. The invention then applies these new cement-based innovations to create unparalleled and new SIPS for the building/construction industry.

Historically the prior arts of the cement based formulations/mixtures of the building/construction industry over the last 160 years has taught that All cement-based formulations/mixtures must all utilize two types of reinforcements-(1) aggregates (sand and gravel) (2) Steel (rebar). This has been a mandatory prerequisite taught prior art without exception.

The prior art teaches that the aggregates (sand and gravel) are integrated or mixed with a cement paste (Portland cement) as a binding agent/element, which is the foundational ingredient, compound and or element of the cement-based formulations/mixtures, thus these formulations/mixtures are classified as cementitious mixtures.

The use of cement paste (Portland cement) as the binding agent/element of the formulations/mixtures in both the prior art and the invention are desirable, preferred, stable and is an unequalled binding agent in terms of being economical, widely available and durable for centuries. The cement paste/binding agent is by itself has a very dense, low/negligible porosity and does not dissolve, emulsify or transform from one state to another once the process of hydration sets the paste into a hardened crystallized state. In other words, it is very stable unlike the sand, gravel and steel reinforcements of the prior art.

It is widely thought that cement-based formulations/mixtures of the prior art are typically only reinforced with steel; when in fact the cement paste/binder is the base composite/matrix and it is reinforced with two reinforcements; 1) Aggregates (sand and gravel), 2 Steel (rebar). The aggregate (sand and gravel) are a localized form of reinforcements in that they are individual/separate small building blocks, which can suffer localized structural failure that in turn can lead into overall catastrophic structural failure. Although the content of sand and gravel are densely, thoroughly and uniformly present throughout the entirety of every single cubic inch of a cement-based formation they lack an interlocking/linked structural integrity of continuity. The cement paste, sand and gravel produce great comprehensive strengths but lack any tensile strengths. In contrast the steel reinforcement represents a very sparse density of the total volume in a cement-based formation. The steel produces the interlocking/linked structural integrity of continuity (tensile strength) that the sand and gravel reinforcements are incapable of delivering. At the end of the day the cement paste/binder of the prior art are typically reinforced by three reinforcements i.e. sand, gravel and steel.

To articulate how sand and gravel perform as reinforcement of the cement paste/binder of cement-based formulations/mixtures of the prior art, the analogy of a block wall being viewed as a microscopic image of cement-based formulations/mixtures will articulate the concept. The blocks of the wall represent the aggregate and the mortar between the blocks represents the cement paste. Structurally speaking one would never want to see a block wall where the mortar joints between the block were three inches thick, as this would produce a very weak block wall. The mortar is not a strong enough material to be used in thickness over ¾ of an inch. Speaking from the logistics of the application of building a block wall; one would never want to lay a course blocks on three-inch bed of mortar as just after the mason completes placing the block exactly to the level of the set string line, moments later the block would sink to an undesired level even if using a very low slump (dry) mortar. Even when laying block on a ½-inch bed of mortar you can experience the level of a block dropping, that is why procedurally you find a mason laying one course horizontally for as far as the run of the course will go before laying another course on top of a lower course that was just laid, in fear of the next correctly laid block would start to sink or drop down below the prior set string level. With that said, the cement paste/binder needs to be properly reinforced with aggregate (sand and gravel) uniformly to achieve the proper density proportion ratio of the cement paste to aggregate reinforcements.

Reinforcement drawbacks of prior art: The major drawbacks that result from the current cement-based formulations/mixtures embodied by the prior art are as follows:

The reinforcements taught in the prior art in formulating cement-based formulations/mixtures and historically over the last 160+years are aggregate (sand and gravel) and steel. This has been the common practice primarily due to the wide availability of quarried limestone and iron ore. It is a widely held belief and practice that cements based formulations/mixtures must be made with sand, gravel and steel wherein it is an unchallenged basis to any and all formulas of cementitious formulations/mixtures. The use of commonly mined limestone and iron type reinforcements in cement-based mixtures are not ideal, but convenient and when thorough performance analysis is conducted it would seem logical that the analyst would recommend replacement materials be explored. The exacting causes of failure are scientifically well known and documented, but the ability to develop innovative solutions are prevented by the mechanics of tradition and standard issue; “Cement-based mixtures are always made with sand, gravel and steel”. “The world is flat” is somewhat of a comparable oblivious concept of the thought process utilized currently. No industry alternatives have been sought in the replacement of sand and gravel reinforcements in cement-based formulations/mixtures as it is such an unconceivable thought that they need to be replaced or even that they could be replaced. All augmentations to the various cement-based formulations/mixtures for sake of addressing these known problems see the formulators keeping the traditional baseline of the formulations/mixtures inclusive of cement paste, sand, gravel and steel to which they add fiber or some type of an admixture seeking to change the characteristic of the formulations/mixtures. Ultimately this methodology does not realize the necessity of radically seeking the replacement reinforcements of the prior art to obtain ultimate success.

The invention teaches a radical replacement of all the reinforcements of the prior art being achieved. The composition of sand and gravel are largely the same and are only different in size, sand is just smaller gravel. Geologically the widely available mined sand and gravel are predominately limestone (80%) with granite, gabbro and basalt (20%). The sand and gravel vary considerably in the structure of their composition from one grain of sand to another to one piece of gravel to another. Sand and gravel are very porous in and by themselves and are the primary source the porosity of cement-based formulations/mixtures overall. In different cementitious mixtures, the larger the size of the aggregate the more porosity will be created. In mixtures such as a thin paint on type of application of “water stop” (hydraulic cement) no aggregates are used at all, this gives the mixture less porosity and an almost “sealer” like property. Some brands of “water stop” are formulated with small amounts of fine sand, which creates an increased level of porosity over the former. The thinner a mixture is applied the less amount and the finer the sand will have to be utilized. Water stop type cement mixtures cannot be used to pour a 6″ inch thick concrete driveway, as the mixture hasn't the larger aggregate structure and would be brittle and crumble. Concrete mixtures cannot be used to plaster a swimming pool as the aggregates are too large and course to be applied is such a thin application and is far to porous to effectively seal a concrete pool. With that said all cement-based formulations/mixtures are very porous and unstable due to sand and gravel being used as reinforcements.

The porous cement-based formulations/mixtures of the prior art allows moisture (vapor and liquid) in combination atmospheric gases produce acidic moisture, which intrudes/infiltrates in and through the porous nature of cement based formulations/mixtures and results in dissolution of the limestone, causing increasing levels of salt movement within the cement-based formation, which furthers the degradation of the aggregate (sand and gravel) and steel reinforcements and decreased longevity of the cement based formulations/mixtures of the prior art

The invention eliminates these referenced problems and produces a significantly stronger and a longer lasting Structural Insulated Panel System (SIPS), due to the invention's new and unique formulations/mixtures and unique and improved manufacturing processes.

### BRIEF SUMMARY OF INVENTION

The primary objective of this invention is to provide the building/construction industry with new and unparalleled SIPS with increased performance characteristics of comprehensive, tensile and flexural strengths, reduction of porosity, increased durability, longevity and solves water intrusion concerns. This objective is achieved through the deployment of new and unique cement-based formulations/mixtures taught by the invention for the interior and exterior facings.
Absolutely no sand, gravel or steel reinforcements are formulated, as the invention teaches the total replacement of all the reinforcements i.e. aggregates (sand and gravel) and steel of the prior art of cement-based formulations and mixtures used to manufacture SIPS and or the teachings of the poured/casted/formed cement based formulations/mixtures and manufacturing processes of the prior art of building/construction industry as a whole.
Glass fiber and textile (glass reinforced woven mesh) reinforcements are exclusively and strategically utilized for the total elimination of the structural failures that stem from the use of the sand, gravel and steel reinforcements of the prior art, whereby the structural stability of future SIPS will be achieved by using the replacement reinforcements taught by the invention.
The teaching of the inventions new and unique formulations/mixtures produce and water tight integrity stopping any water intrusion which is a large failing of the prior art of SIPS. The invention solves this problem by producing water tight integrity which is achieved in the selection of the ingredients of the new and unique formulation and unique and improved manufacturing processes.

Another objective of this invention is to provide SIPS with increased performance characteristics of comprehensive, tensile and flexural strengths, reduction of porosity, increased durability, and longevity. The invention also produces cost saving in the elimination of the purchases and installations of exterior and interior siding and finish effects. This objective is achieved through the deployment of unique and improved manufacturing processes taught by the invention.
The invention teaches that manufacturing the SIPS at dramatically higher temperatures both initially and throughout all the phases of the manufacturing process realizes a radically improved all performance characteristics over the results taught by the prior art.
In manufacturing SIPS, the invention teaches that utilizing new and unique development of the custom casting processes results in substantial material and installation labor cost savings over the manufacturing processes that taught by the prior art. The SIPS of the prior art teaches the “one size panel fits all” design, which requires the installer to modify the panels onsite to totally fabricate and complete structures to be built. The prior art further teaches that when casting a SIPS from a mold the fabricator would fill the entire areas in the mold thus always producing a standard dimensional casting. It is always the case that the dimensions of the standard SIPS of the prior art will not perfectly fit the dimensions of the surface area that is being built, which requires panels needing to be cut or re-sized to provide exacting and proper fitting coverage. This results in unnecessary expenditure of labor and material waste.
The invention teaches an evaluation of the layout of full size panels needed to build a certain surface area and deducing what dimension the remaining panels would need to be re-sized to for a perfect fitting. The invention then further teaches a utilization of a custom cast manufacturing process for producing panel castings to the exacting sizes of the panels required to produce a (no cut-no waste) labor and material cost saving procedure.
It should be noted that NO current SIPS of the prior art offer this new and unique manufacturing process in service to the building/construction industry. The invention is the only SIPS that provide the unparalleled and unique manufacturing process in service to the industry.
The SIPS of the invention are composed of two cement based structural facings which is filled with an insulating Spray Polyurethane Foam (SPF) core. This foam core is not only insulative but is a strong adhesive which bonds the two cement-based structural facings together and adds to the structural strength of the SIPS of the invention through a new and unique manufacturing process not taught nor found in the prior art of SIPS.
The invention produces wide range of integrally molded textures for the exterior cement based structural facings of the SIP panels such as stucco, siding, stone, and brick, etc. which are achieved in the manufacturing processes process not taught nor found in the prior art of SIPS.
The invention produces wide range of integrally molded textures for the interior cement based structural facings of the SIP panels such as stucco/plaster, drywall textures, wood paneling, stone, and brick, etc. which are achieved in the manufacturing processes process not taught nor found in the prior art of SIPS.

Other practical uses and adaptations of this invention should be apparent to those skilled in the art.

### BRIEF DESCRIPTION OF THE DRAWINGS

FIG. 1 is a drawing of a perspective view of the base ingredients of the new and unique formulations and mixtures of the invention.

FIG. 2 is a drawing of a side view of a Structural Insulated Panel casted with the new and unique formulations and mixtures of the invention.

FIG. 3 is a photo of glass fiber.

FIG. 4 is a photo of glass reinforced woven.

FIG. 5 is a photo of the Portland cement.

FIG. 6 is a drawing of a side view of a typical mold and casting of the prior art

FIG. 7 is a drawing of a side view of an improved insulated vacuum mold and casting of the invention.

### DETAILED DESCRIPTION OF THE INVENTION

### New and Unique Cement-Based Formulations/Mixtures of the Invention

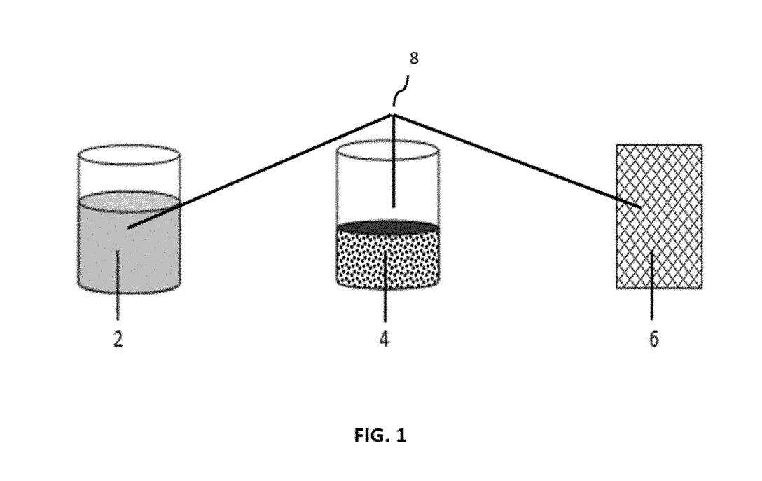

The invention teaches three ingredients are needed for the new and unique formulations/mixtures for manufacturing the SIPS: FIG. 1 is a drawing of a perspective view of the three base ingredients of the new and unique formulations and mixtures of the invention.
2—Portland Cement
4—Glass Fiber
6—Glass Reinforced Woven Mesh

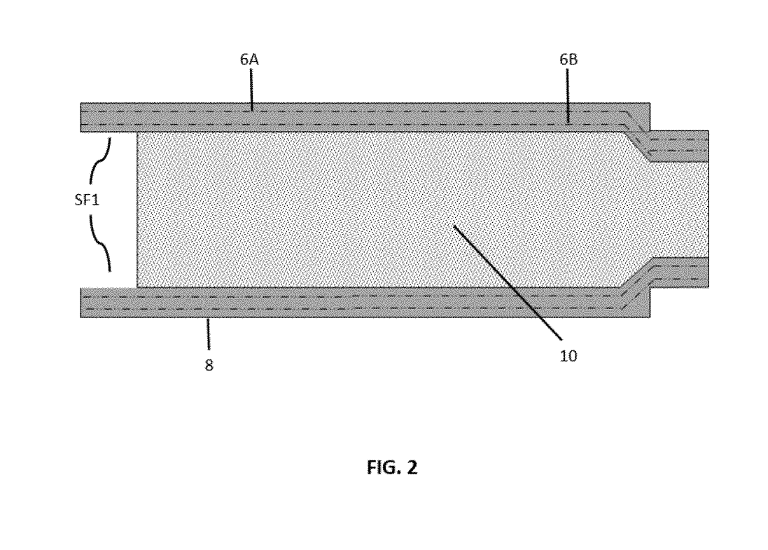

FIG. 2 is a drawing of a side view of a Structural Insulated Panel casted with the new and unique formulations and mixtures of the invention. The Portland cement 2 and glass fiber 4 are mixed together 8 and are reinforced with two layers of the glass reinforced woven mesh 6A/6B as each structural facing is casted. The Spray Polyurethane Foam (SPF) core 10 which bonds the two cement-based structural facings SF1 together and adds to the structural strength of the SIPS of the invention.

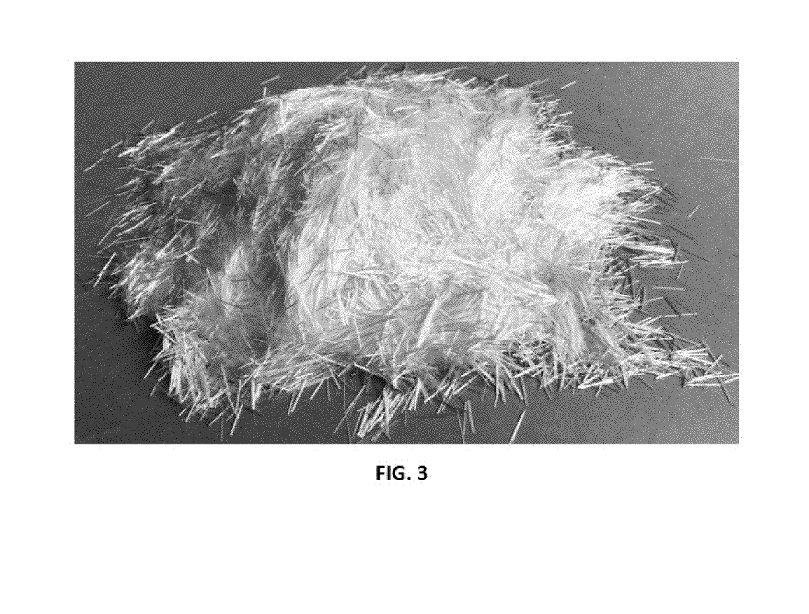

FIG. 3 is a photo of glass fiber.

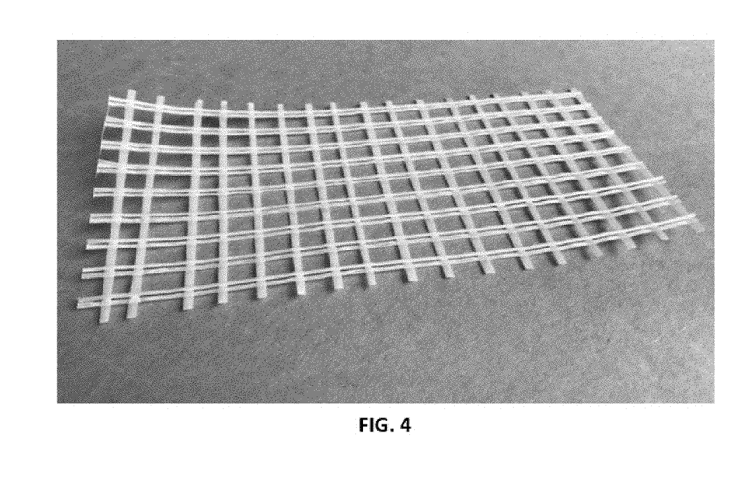

FIG. 4 is a photo of glass reinforced woven.

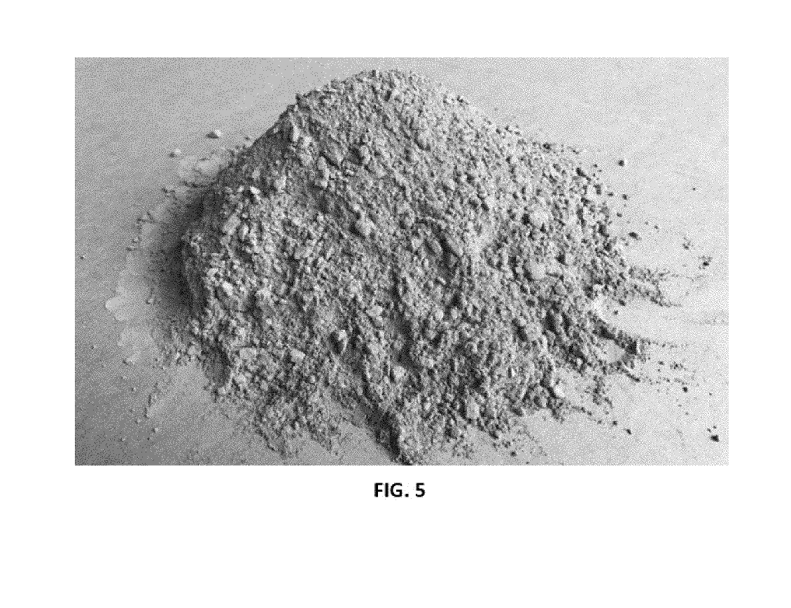

FIG. 5 is a photo of the Portland cement.

Cement/ash Paste/binding agent: The use of Portland cement paste as the binding agent/element of the new and unique formulations/mixtures in the invention is desirable, preferred, stable and is an unequalled binding agent in terms of being economical, widely available and durable for centuries. This cement paste/binding agent is by itself has a very dense, low/negligible porosity and does not dissolve, emulsify or transform from one state to another once the process of hydration sets the paste into a hardened crystallized state. The typical batch size taught by the invention requires 125 lbs of Portland cement to make the cement paste for a batch of a mixture for casting.

There are various types of cements that can be used in the various and different new and unique formulations/mixtures of the invention. The various types of cement to be used are substantiated below, as per ASTM C150:
Type I—High Early Strength
Type II—Moderate specified in said formulations/mixtures ultimately provide vast diversity and agility of application uses and allows specific and targeted performance characteristics to be yielded Sulfate Resistance
Type II (MH)—Moderate Heat of Hydration
Type III—High Early Strength
Type IV—Low Heat Hydration
Type V—High Sulfate Resistance
In addition, blended hydraulic type cements to be inclusive as cements for use in formulation/mixtures of the invention, as per ASTM C595:
Type IL—Portland—Limestone Cement
Type IS—Portland—Slag Cement
Type IP—Portland—Pozzolan Cement
Type IT—Ternary Blended Cement

Glass Fiber Reinforcement—Glass is utilized as a much improved and stable aggregate for the new and unique formulations/mixtures of the invention. There are different types and sizes of glass fiber available for agility with formula diversity in servicing different applications. The invention teaches a variety of ratios for the blending of fiber which can be adjusted to meet specific and targeted performance characteristics. The amount of fiber needed for a batch of cement paste from above—see the fiber batch weights below:

| % of Type-A | % of Type-B | % of Type-C | Total-Lbs |
|---|---|---|---|
| 20% | 30% | 50% | 7 Lbs |
| 21% | 35% | 44% | 8 Lbs |
| 22% | 37% | 40% | 9 Lbs |
| 25% | 40% | 35% | 10 Lbs |

Glass Reinforced Woven Mesh—The invention teaches the utilization of glass reinforced woven mesh to further reinforce the new and unique formulations/mixtures for manufacturing the SIPS of the invention. The invention teaches the placement of two layers of the glass reinforced woven mesh in each of the two cement-based structural facing castings. The invention teaches the use of more layers of the glass reinforced woven mesh to further reinforce the new and unique formulations/mixtures for larger SIP panels capable of increase load bearing characteristics as may be required in serving varied applications.

The invention teaches adjustable formulations in batching the three ingredients for casting SIPS of the invention to provide agility in performance characteristic yields. The key to the successes of the invention is there's absolutely NO use of sand, gravel or steel reinforcements taught by the invention. Instead the invention exclusively teaches the use of cement paste, glass fiber and glass reinforcement woven mesh in producing the new and unique formulations/mixtures of the invention.

### Unique and Improved Manufacturing Processes Taught by the Invention

The invention uniquely teaches the observation and practice of controlling ambient temperature of the production environment of the manufacturing with ranges of between 70° F.-90° F. prior to casting, during casting, and post temperatures during curing of the new and unique formulations/mixtures as an intangible conditioning of the unique and improved manufacturing processes of the invention.

The invention further teaches the elements/compounds/ingredients of the invention formulas are stored at the same temperature ranges. The insulated vacuum molds and all the production tools and equipment used in all the production phases are also stored and utilized at the same increased temperature ranges.

The invention teaches the utilization of insulated vacuum molds which provide efficiencies and effectiveness in the retention of the high temperature releases generated by the inventions new and unique formulations and mixtures in the curing phases. In the curing phase where both the chemical reaction of the cement/pozzolans/water and from the heat that is caused mechanically by the friction of water molecules that hydration produce.

The initial hot water temperatures of 105° F. coupled with the increased temperatures generated during curing along with the insulated vacuum molds that facilitate the retention of these temperatures act like a catalyst in the development of a high temperature accelerated curing of the castings. The invention teaches a methodology of a free high heat baking process with zero energy costs. In this teaching of the invention superior and dramatically increased performance characteristics are yielded. These processes are not taught nor found in the prior art of SIPS and or the teachings of the poured/casted/formed cement based formulations/mixtures and manufacturing processes of the prior art of building/construction industry as a whole

The invention teaches a new and unique high temp moist curing process, which is achieved with the deployment of the “anti-hydration membrane” which under applied vacuum coupled with high temperature produces a beneficial effect of retaining the moisture of the water molecules that normally leave the open un-insulated mold/casting in the hydration/curing phase of the prior art. The invention teaches an improved and more ideal curing conditioning in that the casted formulations/mixtures cure faster and harder due to the retention of an increased moist curing environment over the drier curing environmental conditions taught in the prior art.

These practices are proven to lead to castings with earlier and higher strengths, and the enhanced performance characteristics of comprehensive, flexural (tensile bending), shear, torsion and durability with less porosity, when compared to castings that were produced using cold water, un-improved molds i.e. the manufacturing processes of the prior art.

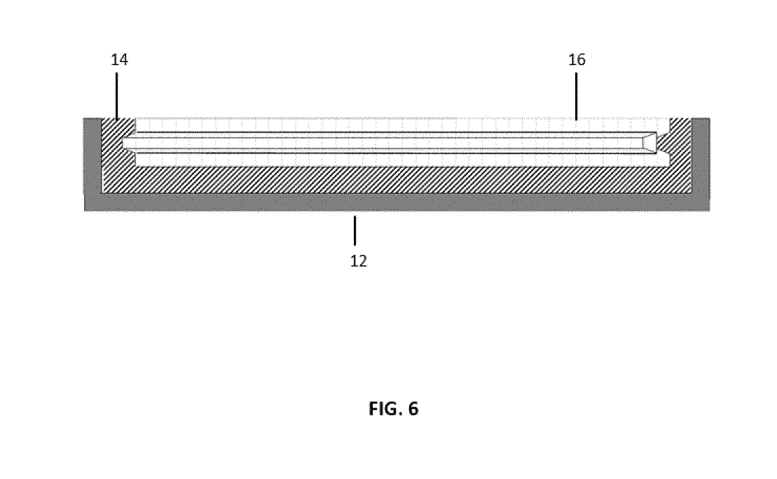

FIG. 6 is a side view of a typical mold of the prior art, which consist of just two elements the hard mold 12 and rubber mold 14 that produces the casting 16. The prior art doesn't teach the three improvements of the invention. (1)—The use of insulated vacuum mold with insulated top. (2)—The use of anti-hydration membrane. (3)—The use of vacuum molding technologies.

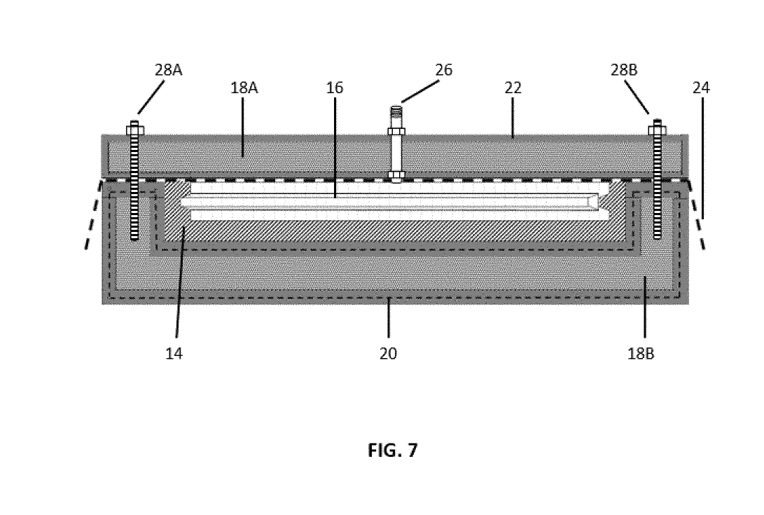

FIG. 7 is a side view of an improved insulated vacuum mold of the invention. The improvements taught by the invention are first the insulated 18B hard mold 20, which holds the rubber mold 14 and provides the profile imaging tooling to produce the designed casting 16. The next improvement is the utilization of the anti-hydration rubber membrane 24, which performs two actions (a) It retains the moisture that normally escapes from the casting/mold during the cure phase. (b) It acts as a gasket between the insulated 18B hard mold 20 and the insulated 18A top 22. The anti-hydration rubber membrane 24 is laid down over the casting 16 once it is completed being casted. The insulated 18A top 22 is bolted 28A/28B down on the insulated 18B hard mold 20 then a vacuum is attached to the vacuum valve 26 and the vacuum is applied to the mold and left to the heated moist curing process over night.

We claim:

1. A variety of new and unique formulations and mixtures of the invention developed to be enhanced formulations and mixtures as radical replacement for all manufacturing processes in which cement-based formulations and mixtures that are utilized in the manufacturing of SIPS of the prior art and or the teachings of the poured/casted/formed cement based formulations/mixtures and manufacturing processes of the prior art of building/construction industry.

2. The new and unique formulations and mixtures as defined in claim 1 wherein said formulations and mixtures of the invention DO NOT utilize any sand, gravel or steel reinforcement of the prior art as ingredients in formulating the new and unique formulations and mixtures of the invention, which are teachings not present, nor found in any of the prior art.

3. The new and unique formulations and mixtures as defined in claim 1 wherein said formulations and mixtures of the invention are taught to be exclusively reinforced with glass fiber and glass reinforced woven mesh, which are teachings not present, nor found in any of the prior art.

4. The new and unique formulations and mixtures as defined in claim 1 wherein said formulations and mixtures of the invention produce a water tight integrity in the structural facing, which prevent water intrusion and doesn't require the installation of a vapor/moisture barrier.

5. The new and unique formulations and mixtures as defined in claim 1 wherein said formulations and mixtures of the invention produce SIPS that is bug, insect, termite-pest/vermin-rodent proof, which are teachings not present, nor found in any of the prior art.

6. The new and unique formulations and mixtures as defined in claim 1 wherein said formulations and mixtures of the invention produce SIPS that is fire proof and does not burn, which are teachings not present, nor found in any of the prior art.

7. The new and unique formulations and mixtures as defined in claim 1 wherein said formulations and mixtures of the invention produce SIPS that does not rot, decay, warp or split and provides excellent mold/mildew resistant, which are teachings not present, nor found in any of the prior art.

8. Unique and improved manufacturing processes of the invention developed to be enhanced augmentation/replacement for all manufacturing processes in which cement-based formulations and mixtures that are utilized in the manufacturing processes of the prior art, which are teachings not present, nor found in any of the prior art.

9. The unique and improved manufacturing processes as defined in claim 4 wherein said manufacturing processes of the invention teaches utilizing high temperature water to manufacture the new and unique formulations/mixtures, which are teachings not present, nor found in any of the prior art.

10. The unique and improved manufacturing processes as defined in claim 4 wherein said manufacturing processes of the invention teaches utilizing insulated vacuum molds to retain the high temperature releases generated in the curing process, which are teachings not present, nor found in any of the prior art.

11. The unique and improved manufacturing processes as defined in claim 4 wherein said manufacturing processes of the invention teaches utilizing a new and unique high temp moist curing process, which is achieved with the deployment of the “anti-hydration membrane” which is placed under applied vacuum, which are teachings not present, nor found in any of the prior art.

12. The unique and improved manufacturing processes as defined in claim 4 wherein said manufacturing processes of the invention teaches utilizing a custom casting process, which save labor and material cost and is not taught by any of the prior art.

13. The unique and improved manufacturing processes as defined in claim 4 wherein said manufacturing processes of the invention teaches utilizing manufacturing process that have created and incorporated a high-temperature casting/curing process that utilize unique and improved insulated vacuum molds which are not practices taught by the prior art.

14. The unique and improved manufacturing processes as defined in claim 8 wherein said manufacturing processes of the invention teaches utilizing manufacturing process that have created and incorporated high-temperature casting/curing methods in which the generation of the high temperature cast/cure effect requires no expenditure of cost for the energy to produce and retain the heat needed for the high temperature casting/curing process.

15. The unique and improved manufacturing processes as defined in claim 4 wherein said manufacturing processes of the invention teaches that the cement based structural facing for the interior of the SIP panel may be put into service without an interior coating, sheeting, or paneling materials .etc. being purchased or installed by unique and improved manufacturing processes, which produce a wide range of integrated molded textures such as stucco/plaster, drywall textures, wood paneling, stone, and brick .etc., which are achieved in the manufacturing processes.

16. The unique and improved manufacturing processes as defined in claim 4 wherein said manufacturing processes of the invention teaches that the cement based structural facing for the exterior of the SIP panel may be put into service without an exterior coating, sheeting, or siding materials .etc. being purchased or installed by unique and improved manufacturing processes, which produce a wide range of integrated molded textures such as stucco/plaster, lapped siding, stone, and brick .etc., which are achieved in the manufacturing processes.
